(19) United States
(12) Patent Application Publication
(10) Pub. No.: US 2023/0174386 A1
(43) Pub. Date: Jun. 8, 2023

(54) SCALABLE SYNTHESIS OF SEMI-CONDUCTING CHEVREL PHASE COMPOUNDS VIA SELFPROPAGATING HIGH TEMPERATURE SYNTHESIS

(71) Applicant: OHIO STATE INNOVATION FOUNDATION, Columbus, OH (US)

(72) Inventors: Pelagia-Iren GOUMA, Columbus, OH (US); Milind Mansing PAWAR, Columbus, OH (US)

(21) Appl. No.: 17/923,829

(22) PCT Filed: May 7, 2021
(86) PCT No.: PCT/US2021/031320

§ 371 Date: Nov. 7, 2022

Related U.S. Application Data
(60) Provisional application No. 63/021,359, filed on May 7, 2020.

(51) Int. Cl. C01G 39/06; C01G 49/12

(52) U.S. Cl. CPC C01G 39/06; C01G 49/12; C01P 2006/40; C01P 2004/41

(57) ABSTRACT

Methods for the scalable and systematic synthesis of semiconducting Chevrel phase compounds via self-propagating high temperature synthesis (SHS) are provided. The provided methods utilize elemental precursors not utilized by typical synthesis methods. The precursors may include molybdenum (Mo), molybdenum disulfide (MoS₂), and a ternary cation. In various aspects, the ternary cation may be copper (Cu), iron (Fe), or nickel (Ni). The utilization of the provided precursors and SHS decreases the time it takes to synthesize Chevrel phase compounds as compared to typical heat treatment methods.

### PRIORITY CLAIM

The present application claims priority to and the benefit of U.S. Provisional Application 63/021,359, filed May 7, 2020, the entirety of which is herein incorporated by reference.

### TECHNICAL FIELD

The present application relates generally to synthesizing Chevrel phase compounds. More specifically, the present application provides new and innovative methods for the synthesis of semiconducting Chevrel phase compounds via self-propagating high temperature synthesis (SHS).

### BACKGROUND

Chevrel phase compounds constitute a versatile material system consisting of a large number of cluster compounds based on molybdenum chalcogenides which have typically been studied as superconductors at low temperatures. There is limited information on how Chevrel phase compounds behave at room temperature and above. Additionally, no phase diagrams are available for Chevrel phase compounds, only a few simulations of their energy bands' structure have been created, and there is just rare evidence of the semiconducting nature of some of these materials.

The typical Chevrel phase compounds are ternary molybdenum (Mo) chalcogenides with a chemical formula M_{X}Mo₆X₈, where x=0 to 4 and X=a chalcogen (e.g., S, Se, Te) but can be partially substituted by halogens elements or oxygen. Additionally, Mo may be partially or totally replaced by another transition metal (e.g. W, Nb, Ta, Re). Chevrel phase compounds belong to a unique and versatile family of materials with diverse crystal structures and outstanding properties. The interest in these materials initially stemmed from their high temperature superconducting and magnetic properties leading to studies of some of their bulk structures. The majority of theoretical work, however, has focused on Mo₆Se₈ clusters as thermoelectrics. Accordingly, methods are needed for sulfide-based Chevrel phase compounds and their semiconducting properties.

Chevrel phase compounds have numerous potential applications in personalized health, homeland security, and infrastructure. Moreover, since Chevrel phase compounds allow for the fast and reversible insertion of various cations in their structures at room temperature, they have potential applications as: (i) cathodes in batteries for electric vehicles (e.g. Mg₂Mo₆S₈; Cu₂Mo₆S₈); (ii) catalysts and sensors (Cu, Fe, Co Chevrel phases); and/or (iii) thermopower and thermoelectric materials with low thermal conductivity and high efficiency of heat conversion into electricity (Mo₂Re₄Se₈; (Fe, Co)_{X}Mo₆Se₈).

In one particular example, there is an increasing demand for a novel approach to satisfy energy production and storage demands as well as environmental protection requirements via renewable, safe, climate-neutral energy resources. One promising approach is to utilize the concept of electrochemical energy conversion because it can be used for production of fuel and for storage of energy while using climate-neutral fuels. In particular, the electrolysis of water to produce hydrogen as fuel (i.e. Hydrogen Evolution Reaction (HER)) has been proposed as a clean energy resource for many years. In order to scale the HER approach, low cost, high-performance electrocatalysts are needed that can perform in a wide range of environments, e.g., in various pH media. Platinum and its alloys have shown promising results as HER catalysts. However, high materials costs along with less abundance of platinum creates the need for an exploration of alternative solutions. One such potential solution is metal chalcogenides, such as Chevrel phase compounds. Typical synthesis methods for Chevrel phase compounds, however, are slow and require the use of a substrate to support an electrocatalyst, which hinders Chevrel phase compounds' potential efficiency and scalability to solve the above-described energy problem.

Lack of controlled and scalable synthesis of the Chevrel phases, however, limits their study and potential uses. Typically, molybdenum chalcogenides are processed as powders by solid-state synthesis followed by ball milling to reduce their sizes. As thin films, many of these compounds have been produced by metal organic chemical vapor deposition (MOCVD), laser ablation, or other thin film generation techniques. Even in their two-dimensional form, when processing of Chevrel phase compounds is based on colloidal solutions, controlled synthesis of these compounds is typically not scalable. It has also been proven to be very difficult to grow many of these materials in single crystalline form. These limitations are a major barrier for the industrial use of these versatile Chrevrel phase compounds considering their potential for wide applicability. Furthermore, even though bulk properties have been studied for several different systems of Chevrel Phases, there is no clear understanding of the surface interactions of these materials with various species (electrolytes, gaseous analytes, etc.). The latter needs to be determined in order to develop advanced energy systems using this unique materials system.

Self-propagating high temperature synthesis (SHS) employs highly exothermic and explosive reactions when elemental mixtures are briefly exposed to the temperature that ignites these reactions. SHS has been explored as scalable synthesis method for refractory materials (e.g. Aluminum Nitride, TiC/NiAl and TiC/Ni₃Al), intermetallics (e.g. Ni—Al intermetallics), and other ceramic systems (e.g. β-SiC powder) at industrial scale. Once the SHS reaction begins a combustion wave is generated due to the intense heat evolution from the highly exothermic reactions (which can reach temperatures up to 4000-5000 K). This combustion wave, or solid flame as it is called, propagates through the sample in a self-sustaining manner.

Electrospinning has similar characteristics to those of electro spraying and dry spinning of fibers since it uses an external electric field to draw the polymer fibers from a solution. During the electrospinning process, electrostatic charge is built upon the surface of a fluid in a capillary when an external electric field is applied to said capillary. The surface tension of the droplet occurring on the top of the capillary is weakened by electrostatic repulsion, and a charged cone is gradually formed at the tip of the capillary tube; this cone is known as a Taylor cone. When the strength of the electric field increases to a threshold, the charge repulsion on the fluid surface becomes larger than its surface tension. This results in an electrically charged fluid jet erupting from the tip of the Taylor cone. The formed jet is then accelerated towards a grounded collector plate. During this time the solvent is evaporated or solidified and the polymer within the jet becomes highly stretched and forms a fiber. The final result is a non-woven mat of nanofibers deposited onto the grounded collector. Electrospinning of a ternary Chevrel phase compound has been shown.

Accordingly, a need exists for a scalable, systematic approach for the synthesis of Chevrel phase compounds via SHS.

### BRIEF DESCRIPTION OF THE DRAWINGS

FIGS. 1A to 1C illustrate a crystal structure of Chevrel phase compounds.

FIG. 2 illustrates a flow chart of an example method for synthesizing a Chevrel phase compound, according to an aspect of the present application

FIG. 3 illustrates an example setup for performing the method of FIG. 2, according to an aspect of the present application.

FIG. 4 illustrates time lapsed pictures of a self-propagating high temperature synthesis reaction.

FIG. 5 illustrates x-ray diffraction results of an as-processed material consisting of a mixture of non-stoichiometric Chevrel phase compound and MoS₂.

FIGS. 6A and 6B show scanning electron microscope (SEM) images that show the Chevron phase compound formed cubic clusters while MoS₂ formed plates with spirals having nano-step formation.

FIG. 7A illustrates a SEM image of cube-like clusters of the Chevrel phase compound.

FIG. 7B illustrates a SEM image of rosette plates of MoS₂.

FIG. 8A illustrates a magnified portion of the SEM image of FIG. 8B showing the presence of a helical spiral indicated with a blue triangle.

FIG. 8B illustrates a SEM image showing MoS₂ platelets.

FIG. 8C illustrates a magnified portion of the SEM image of FIG. 8B showing MoS₂ spiral plates with nano-step formation.

FIG. 9 illustrates a schematic of a reaction mechanism provided by the present disclosure during self-propagating high temperature synthesis of a Chevrel phase compound.

FIG. 10 illustrates x-ray diffraction data for material synthesized via the provided Chevrel phase compound synthesis method and for material synthesized via a conventional Chevrel phase compound synthesis methods.

FIG. 11 illustrates x-ray diffraction data for a synthesized Ni₂Mo₆S₈ sample.

FIG. 12 illustrates x-ray diffraction data for a synthesized Fe₂Mo₆S₈ sample.

FIGS. 13A to 13C illustrate an example high-throughput electrospinning setup of the present disclosure.

FIGS. 14A and 14B illustrate transmission electron micrographs showing microstructures formed by the provided method.

### SUMMARY

The present application provides new and innovative systems and methods for the scalable and systematic synthesis of semiconducting Chevrel phase compounds via self-propagating high temperature synthesis (SHS).

In light of the technical features set forth herein, and without limitation, in a first aspect of the disclosure in the present application, which may be combined with any other aspect unless specified otherwise, a method for synthesizing a Chevrel phase compound includes combining a set of elemental precursors including molybdenum (Mo), molybdenum disulfide (MoS₂), and a ternary cation. The combined set of elemental precursors may be subjected to an environment adapted for self-propagating high temperature synthesis of the combined set of elemental precursors, thereby synthesizing a Chevrel phase compound. The synthesized Chevrel phase compound may be removed from the environment.

In a second aspect of the disclosure in the present application, which may be combined with any other aspect unless specified otherwise, the ternary cation is copper (Cu).

In a third aspect of the disclosure in the present application, which may be combined with any other aspect unless specified otherwise, the ternary cation is iron (Fe).

In a fourth aspect of the disclosure in the present application, which may be combined with any other aspect unless specified otherwise, the ternary cation is nickel (Ni).

In a fifth aspect of the disclosure in the present application, which may be combined with any other aspect unless specified otherwise, the synthesized Chevrel phase compound has at least one of catalytic, photocatalytic, and sorbent properties.

In a sixth aspect of the disclosure in the present application, which may be combined with any other aspect unless specified otherwise, the Chevrel phase compound is synthesized in 10 minutes or less of the combined set of elemental precursors being subjected to the environment.

In a seventh aspect of the disclosure in the present application, which may be combined with any other aspect unless specified otherwise, the Chevrel phase compound is synthesized in less than 15 seconds of the combined set of elemental precursors being subjected to the environment.

In an eighth aspect of the disclosure in the present application, which may be combined with any other aspect unless specified otherwise, the synthesized Chevrel phase compound does not require further treatment subsequent to the self-propagating high temperature synthesis.

In a ninth aspect of the disclosure in the present application, which may be combined with any other aspect unless specified otherwise, the environment is within a tube furnace.

In a tenth aspect of the disclosure in the present application, which may be combined with any other aspect unless specified otherwise, the combined set of elemental precursors is encapsulated within an encapsulating instrument when subjected to the environment.

In an eleventh aspect of the disclosure in the present application, which may be combined with any other aspect unless specified otherwise, the encapsulating instrument is a quartz tube.

In a twelfth aspect of the disclosure in the present application, which may be combined with any other aspect unless specified otherwise, the air is removed from the atmosphere within the encapsulating instrument.

In a thirteenth aspect of the disclosure in the present application, which may be combined with any other aspect unless specified otherwise, the combined set of elemental precursors is encapsulated within an argon (Ar) atmosphere within the encapsulating instrument.

In a fourteenth aspect of the disclosure in the present application, which may be combined with any other aspect unless specified otherwise, the environment has a temperature greater than or equal to 800° C. and less than or equal to 1100° C.

In a fifteenth aspect of the disclosure in the present application, which may be combined with any other aspect unless specified otherwise, the environment has a temperature of 1000° C.

In a sixteenth aspect of the disclosure in the present application, which may be combined with any other aspect unless specified otherwise, the environment has a temperature of 1050° C.

In a seventeenth aspect of the disclosure in the present application, which may be combined with any other aspect unless specified otherwise, combining the set of elemental precursors includes electrospinning the set of elemental precursors.

In an eighteenth aspect of the disclosure in the present application, which may be combined with any other aspect unless specified otherwise, the synthesized Chevrel phase compound is in the form of nanofibers.

In a nineteenth aspect of the disclosure in the present application, which may be combined with any other aspect unless specified otherwise, a method for synthesizing a Chevrel phase compound includes combining a set of elemental precursors including copper (Cu), molybdenum (Mo), and molybdenum disulfide (MoS₂). The combined set of elemental precursors is encapsulated in an encapsulating instrument. The encapsulated combined set of elemental precursors may then be subjected to an environment adapted for self-propagating high temperature synthesis of the combined set of elemental precursors, thereby synthesizing a Chevrel phase compound. The environment has a temperature of 1000° C. The synthesized Chevrel phase compound may then be removed from the environment.

In a twentieth aspect of the disclosure in the present application, which may be combined with any other aspect unless specified otherwise, a method for synthesizing a Chevrel phase compound includes combining a set of elemental precursors including (i) molybdenum (Mo), (ii) molybdenum disulfide (MoS₂), and (iii) nickel (Ni) or iron (Fe). The combined set of elemental precursors is encapsulated in an encapsulating instrument. The encapsulated combined set of elemental precursors may then be subjected to an environment adapted for self-propagating high temperature synthesis of the combined set of elemental precursors, thereby synthesizing a Chevrel phase compound. The environment has a temperature of 1050° C. The synthesized Chevrel phase compound may then be removed from the environment.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### DETAILED DESCRIPTION

The present application provides new and innovative methods for the scalable and systematic synthesis of semiconducting Chevrel phase compounds via self-propagating high temperature synthesis (SHS). The provided method decreases the time it takes to synthesize Chevrel phase compounds compared to typical heat treatment methods due to the ultra-fast nature of SHS, which belongs to the combustion processes and is versatile, rapid, and requires almost no specialized equipment. SHS is based on self-sustaining (exothermic) reactions fueled by the energy released upon mixing of the reacting components. The provided methods utilize elemental precursors not utilized by typical synthesis methods. The precursors may include molybdenum (Mo), molybdenum disulfide (MoS₂), and a suitable ternary cation. In various aspects, the ternary cation may be copper (Cu), iron (Fe), or nickel (Ni). The provided method may also combine high-throughput electrospinning with SHS. In some aspects, the provided method may also include a variation of the flame sprayed process, which involves the pyrosol process.

Additionally, with respect to energy production and storage applications, the presently disclosed method may enable substrate-free production of self-supported, highly porous 3D nanofibrous Chevrel phase compounds with tailored composition and phase for a highly efficient Hydrogen Evolution Reaction (HER). In addition, since efficiency of hydronium protonation is affected by oxidation state of Mo, one can tailor its oxidation state by introducing different ternary cation to Chevrel phase compounds (e.g. Fe, Ni, Co). Further, porous nano-structures Chevrel phase with open channels may facilitate an improved hydrogen adsorption efficiency by exposing more Mo atoms with reduced oxidation state. Moreover, study of reduced oxidation state of Mo and effect of ternary cation on HER is of utmost importance for utilization of high temperature stable Chevrel phase compounds.

Chevrel phase compounds are amenable to crystallographic control of their electronic structure and physical properties. The geometric and electronic characteristics of the Chevrel phase compounds rely on the cluster configuration and thus can be manipulated for both advanced chemical reactivity and selectivity. There exists a need therefore to determine the effect of M radon arrangement on electronic and surface properties, specifically determining cations which give rise to semiconducting behavior in Molybdenum Sulfide Chevrel phase compounds. The close link between novel synthesis and advanced microscopy approaches will readily determine the crystal structures of the as-synthesized phases and will establish how structural variations impact the functional properties (gas sensing, catalysis) of Chevrel phases. Model systems may include: Cu₄Mo₆S₈, Cu₂FeMo₆S₈, and TiMo₆S₈. For these Chevrel phase compounds, the valence electron concentration is four. They are also known to have low thermal conductivity resembling that of glasses, which has been attributed to the “rattling” of the Cu, Fe or Ti atoms in the voids of the Chevrel structure.

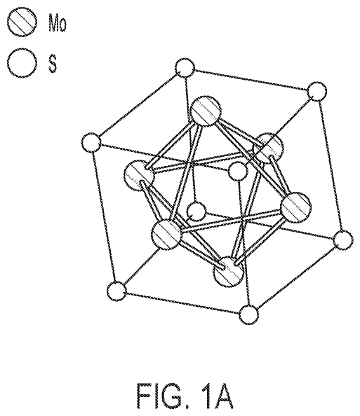

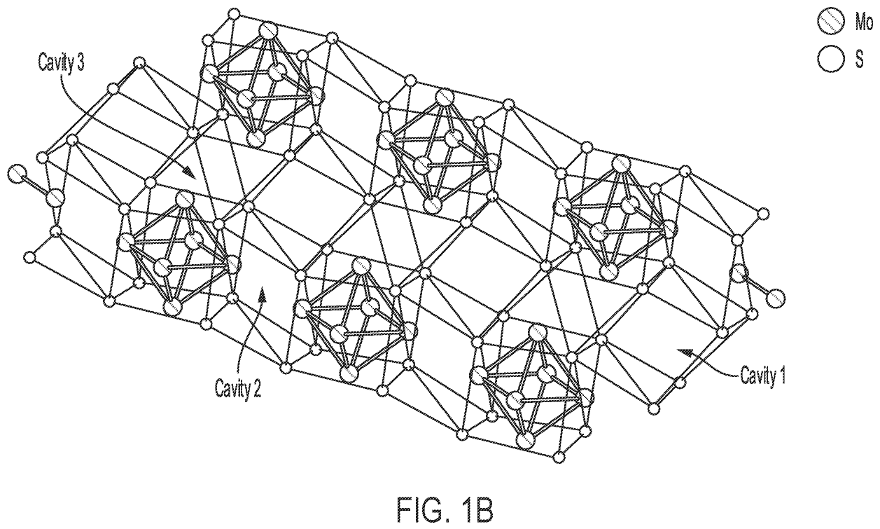

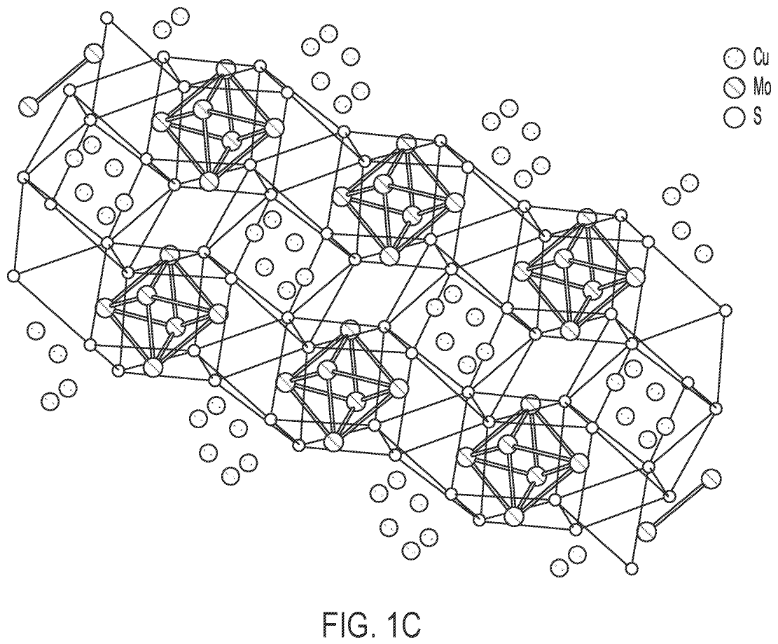

The crystal structure of Chevrel phase compounds is based on the Mo₆X₈ unit, which consists of a Mo₆ octahedron “cluster” surrounded by eight chalcogens arranged in a distorted cube configuration, as shown in FIG. 1A. For the M-element cations, their ionic radius determines their position within the rhombohedral unit cell of these materials. The oxidation state of the cation (Mⁿ⁺) is a critical parameter that determines the physical properties of the material, due to its electronic interactions with the Mo₆X₈ unit. In a typical Chevrel phase compound crystal structure, six molybdenum atoms sit around the ternary axis. Here, it can be considered as a stacking of Mo₆S₈ clusters in three dimensions. In a building block of Mo₆S₈, sulfur atoms form a slightly distorted cube with molybdenum atoms sitting slightly outside the face of each side forming the octahedron.

The stacking of these Mo₆S₈ clusters results in short Mo—Mo— bond (intracluster) distances. Isolated Mo₆S₈ clusters have hexagonal 3-symmetry. Compact arrangement of clusters is positioned in such a way that by the rotation of each cluster by ˜27° around the ternary axis yields the true structure of the Chevrel phase compound. This rotation provides close contact between the molybdenum atoms of the cluster with the six sulfur atoms of the surrounding clusters. Molybdenum atoms in each octahedron are in close proximity of five sulfur atoms in a formation of square-based pyramid. In a square-based pyramid, four of the sulfur atoms belong to the same cluster (face of the cluster) and the fifth sulfur atom belongs to the nearest cluster which acts as an apex of the pyramid. With this context, six of the sulfur atoms in a cluster belong to the square base of a pyramid and two of the sulfur atoms are an apex of the square base pyramids.

Such a peculiar arrangement produces three different cavities between clusters of Mo₆S₈, as shown in FIG. 1B. The largest cavity (Cavity 1) creates a pseudo-cube with eight sulfur atoms that belong to eight separate clusters. The position of a cavity 1 is at the origin of the rhombohedral unit cell. Cavity 2 is located between two consecutive positions designated as cavity 1 with a distorted shape configuration and having chalcogen atoms surrounding it. Cavity 3 is formed between two consecutively mis-aligned Chevrel clusters of Mo₆S₈. As shown in FIG. 1C, these cavities get filled with ternary cations, depending on their size. These cavities create channels running along them due to an interconnected network. Such a network can act as a host for more than 40 different ternary cations.

The effect of ternary cations on a cluster of Mo₆S₈ has been studied and the charge transfer effect was proven based on the X-ray diffraction results of a series of different compounds. The Mo₆ octahedron in a Chevrel phase compound has less than 24 valence electrons, which are required to form an undistorted Mo₆ octahedron. As the number of ternary cation Cu increases in the system, the number of available valence electrons increases through charge transfer. These available valence electrons are responsible for the contraction in the Mo₆ octahedron. The number of valence electrons available for Mo—Mo bonding is referred to as the “Cluster-Valence-Electron-Concentration” (C-VEC). Similar behavior of the contraction in Mo₆ octahedron has been observed for other ternary cations as well. The effect of C-VEC on the Fermi-level in the conduction band is crucial as it changes the electronic properties of the material.

Due to the presence of occupied states and unoccupied states in close vicinity of the Fermi level, the band gap of Mo₆S₈ becomes zero. It has been shown that the pd states of Mo₆S₈ have the total number of electrons: (8×4)+(6×6)=68 and the addition of four electrons can induce the band gap in Mo₆S₈ clusters. If four electrons are made available to the cluster via the insertion of a ternary cation, then a transition from metal to a semiconductor is feasible.

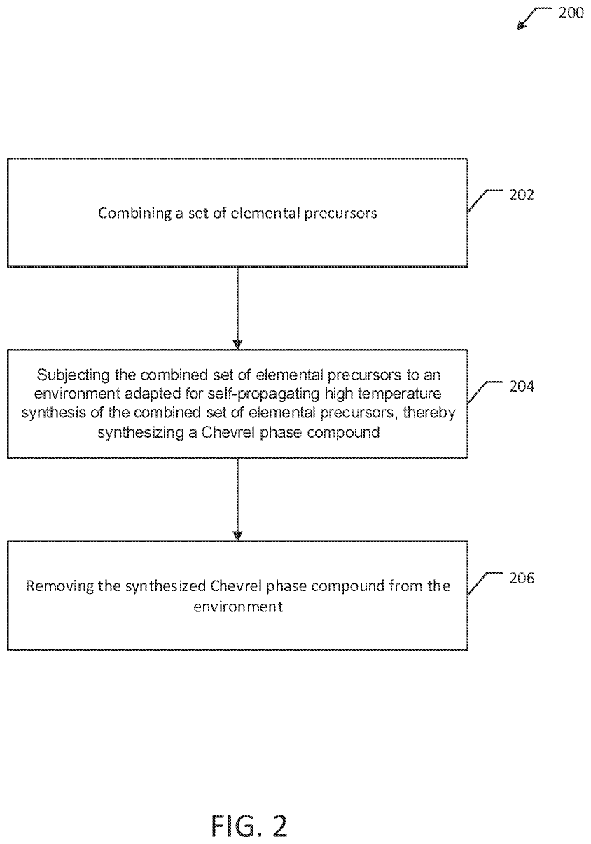

FIG. 2 illustrates a flowchart of an example method 200 for synthesizing a Chevrel phase compound. Although the example method 200 is described with reference to the flowchart illustrated in FIG. 2, it will be appreciated that many other methods of performing the acts associated with the method 200 may be used. For example, the order of some of the blocks may be changed, certain blocks may be combined with other blocks, and some of the blocks described are optional. In at least some aspects, the method 200 may begin by combining a set of elemental precursors (block 202). The set of elemental precursors may be in powder form when combined. The set of elemental precursors may include molybdenum (Mo) and molybdenum disulfide (MoS₂). In various aspects, the set of elemental precursors may further include a suitable ternary cation, such as copper (Cu), iron (Fe), or nickel (Ni). For instance, in one example, the set of elemental precursors is Cu, Mo, and MoS₂. In another example, the set of elemental precursors is Fe, Mo, and MoS₂. In another example, the set of elemental precursors is Ni, Mo, and MoS₂. These combinations of precursor materials have not been used in typical methods. The use of MoS₂ as a precursor may eliminate sublimation of sulfur during heat-treatment.

The elemental precursors may be combined in a ratio that achieves a desired final stoichiometry of the Chevrel phase compound. For example, if Cu₄Mo₆S₈ is the desired Chevrel phase compound, then the atomic or molar ratio of the elemental precursors Cu, Mo, and MoS₂ would be 4Cu:2Mo:4MoS₂ and the elemental precursors Cu, Mo, and MoS₂ can be combined in this ratio. For instance, a weight of each of Cu, Mo, and MoS₂ for combination may be determined based on this atomic or molar ratio and the molar mass of each of Cu, Mo, and MoS₂. In another example, if Cu₂Mo₆S₈ is the desired Chevrel phase compound, then the atomic or molar ratio of the elemental precursors Cu, Mo, and MoS₂ would be 2Cu:2Mo:4MoS₂ and the elemental precursors Cu, Mo, and MoS₂ can be combined in this ratio. In another example, if Ni₂Mo₆S₈ is the desired Chevrel phase compound, then the atomic or molar ratio of the elemental precursors Ni, Mo, and MoS₂ would be 2Ni:2Mo:4MoS₂ and the elemental precursors Ni, Mo, and MoS₂ can be combined in this ratio. In another example, if Fe₂Mo₆S₈ is the desired Chevrel phase compound, then the atomic or molar ratio of the elemental precursors Fe, Mo, and MoS₂ would be 2Fe:2Mo:4MoS₂ and the elemental precursors Fe, Mo, and MoS₂ can be combined in this ratio.

In some aspects, the combined set of elemental precursors may be encapsulated within an encapsulating instrument. For instance, the combined set of elemental precursors may be encapsulated in a glass or quartz tube. The combined set of elemental precursors may be encapsulated within a suitable atmosphere. In one example, the combined set of elemental precursors are encapsulated under vacuum. Stated differently, in such an example, the air is removed from the atmosphere within the encapsulating instrument that encapsulates the combined set of elemental precursors. In another example, the combined set of elemental precursors may be encapsulated within an argon (Ar) atmosphere (e.g., high purity Ar). In such an example, a pressure of the Ar gas within the encapsulating instrument may be less than or equal to one-fifth atmospheric pressure.

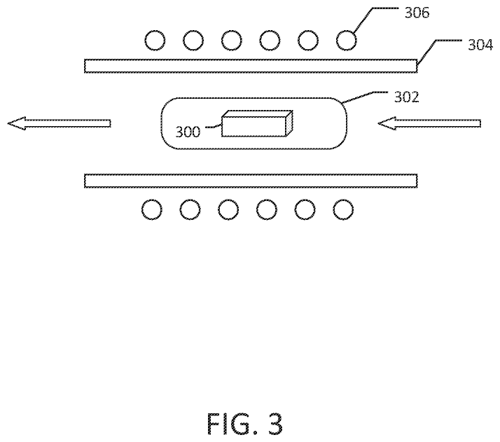

The combined set of elemental precursors may then be introduced into an environment adapted for self-propagating high temperature synthesis of the combined set of elemental precursors (block 204). Introducing the combined set of elemental precursors into this environment thereby synthesizes a Chevrel phase compound via self-propagating high temperature synthesis. In at least some aspects, the combined set of elemental precursors may be introduced into a furnace, such as a tube furnace. For example, FIG. 3 illustrates a combined set of elemental precursors 300 encapsulated in a quartz tube 302 being introduced into a tube furnace 304 in the direction of the arrow pointing into the tube furnace 304. The tube furnace 304 includes heating coils 306. Returning to the example method 200 of FIG. 2, in some aspects, the temperature of the environment (e.g., within the furnace) may be greater than or equal to 800° C. and less than or equal to 1100° C. In some aspects, the temperature of the environment may be greater than or equal to 800° C. and less than or equal to 1000° C. In some aspects, the temperature of the environment may be greater than or equal to 900° C. and less than or equal to 1100° C. In some aspects, the temperature of the environment may be greater than or equal to 1000° C. and less than or equal to 1100° C. In one example, the temperature of the environment may be 1000° C. In another example, the temperature of the environment may be 1050° C.

The method 200 enables synthesizing the Chevrel phase compound in a reduced amount of time as compared to typical heat treatment methods for synthesizing a Chevrel phase compound. For instance, typical heat treatment methods may take many hours (e.g., 60+ hours) to synthesize a Chevrel phase compound, whereas the method 200 enables synthesizing a Chevrel phase compound in a matter of minutes or even seconds. Stated differently, the method 200 enables synthesizing a Chevrel phase compound in less than an hour. In at least some instances, the method 200 enables synthesizing a Chevrel phase compound in less than 30 minutes. In at least some instances, the method 200 enables synthesizing a Chevrel phase compound in less than 15 minutes. In one example, the method 200 enables synthesizing a Chevrel phase compound in 10 minutes or less. In another example, the method 200 enables synthesizing a Chevrel phase compound in less than 15 seconds (e.g., 11 seconds).

After the Chevrel phase compound is synthesized, it may be removed from the environment (block 206). For example, the quart tube 302 in FIG. 3 may be removed from the tube furnace 304 in the direction of the arrow pointing out of the tube furnace 304. The presently disclosed method therefore enables forming completely transformed Chevrel phase compounds from elemental precursors faster than typical synthesis methods by utilizing self-propagating high temperature synthesis. The synthesized Chevrel phase compound via the provided method does not require further treatment after being synthesized. In various instances, the synthesized Chevrel phase compound has at least one of catalytic, photocatalytic, and sorbent properties.

In some aspects, the provided method may additionally utilize high-throughput electrospinning with self-propagating high temperature synthesis. For instance, electrospinning may be performed with the elemental precursors before the elemental precursors are introduced into the environment adapted for self-propagating high temperature synthesis. In an example, the elemental precursors may be encapsulated in a polymer solution. The encapsulated elemental precursors in the polymer solution may then be electrospun to form films. The electrospun films may then be introduced into the environment adapted for self-propagating high temperature synthesis. In various aspects, sol-gel precursors may be employed with high-throughput electrospinning. The addition of electrospinning helps synthesize different morphologies of the final Chevrel phase compound. In at least one example, electrospinning may be performed to synthesize nanofibers of the final Chevrel phase compound.

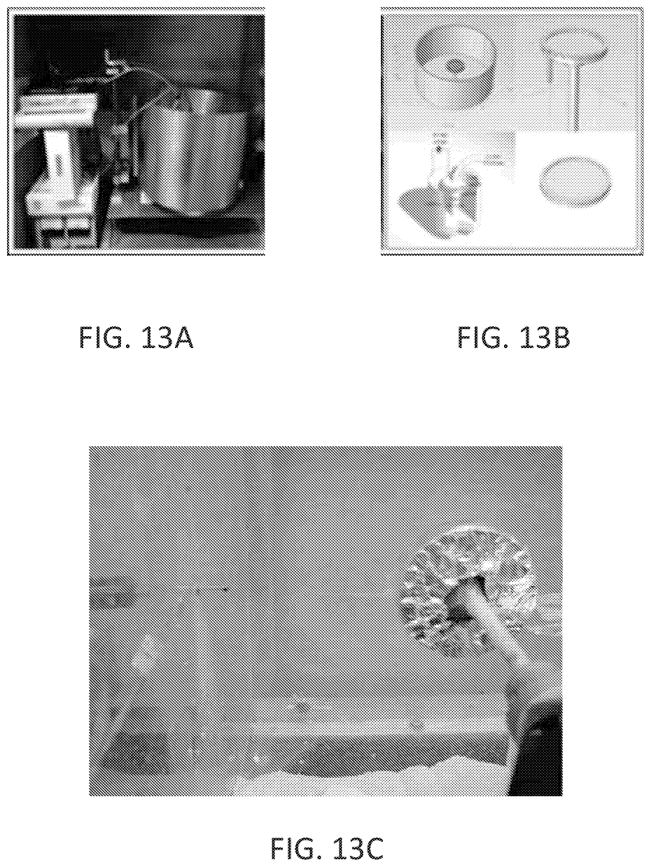

FIGS. 13A to 13C illustrate an example high-throughput electrospinning setup of the present disclosure. This high-throughput electrospinning setup was designed to directly mimic the conventional single needle/jet electrospinning setup so all parameters such as working voltage, concentration of solution, etc. remain the same. As such, laboratory recipes need not be changed when scaling up from the traditional lab setup to the provided high throughput setup. The solution may be pumped into the disk with the help of a syringe pump. The flow rate is kept at a relatively high value, about ten times higher than the traditional needle ml/min in electrospinning. There are a plurality of holes (e.g., 24 holes) drilled at the bottom of the disk. Furthermore, the charge accumulation and the charge distribution are homogeneous at the edge of the bottom plate. A working distance (e.g., 15 cm) can be tailored to the needs of the project.

During high-throughput electrospinning, the solution is continuously pumped into the hollow disk so that every hole of the spinneret is filled with the pre-cursor solution. Meanwhile, the excessive solution flows out from the hole once the disk is full. The increased applied voltage results in a number of jets emerging from the holes. In the provided method, oxygen and water are excluded to avoid O substituting for S in the unit cluster. In at least some aspects, calcination is carried out in argon (Ar), rather than a nitrogen atmosphere, so as to avoid MoN formation.

Although Chevrel phase compounds are highly promising and truly versatile, their study and use has been limited by difficulties in producing stoichiometric and monophasic materials. In some aspects, the provided method may utilize the process of spray pyrolysis for post-treatment of a synthesized Chevrel phase compound. For instance, the spray pyrolysis process may be utilized to control both the composition and the phase selection for a given Chevrel phase compound. In an example, the spray pyrolysis process can be used to deposit Chevrel phase compound particles on a surface of a substrate. In some aspects, the provided method may include a variation of the flame-spray process that involves the pyrosol process.

The pyrosol process, or nebulized spray pyrolysis, utilizes an ultrasonic atomizer/nebulizer to generate an aerosol spray of sub micrometer size droplets. The pyrosol process has been used to produce high quality thin films of metal oxides and binary, ternary and quaternary chalcogenides. The pyrosol process is considered to be close to metal organic chemical vapor deposition (MOCVD) with the added advantages of (i) a wide range of source compounds is available for use in pyrosol synthesis and (ii) being an inexpensive process compared to chemical vapor deposition (CVD)/MOCVD. The thickness of the deposited films may range from tens of nanometers to microns. In various aspects, sol-gel precursors may be employed, such as the sol-gel precursors used in high-throughput electrospinning.

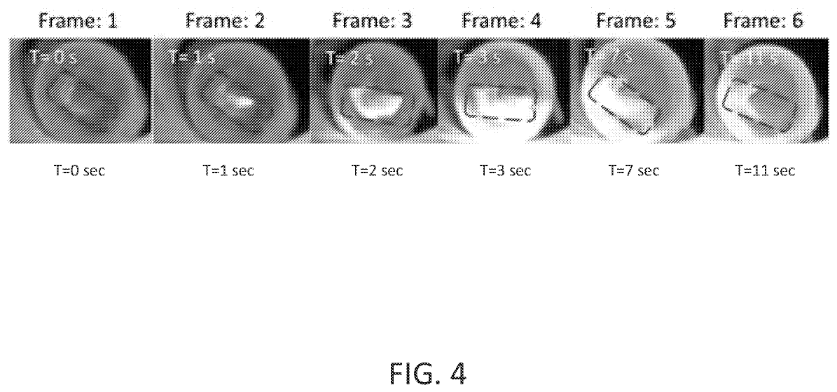

The inventors validated the provided method in an experiment as follows. An initial green pellet of a stoichiometric mixture of elemental Cu, Mo, and S (to achieve Cu₂Mo₆S₈) was prepared and the sample was encapsulated in a glass ampule under an argon atmosphere. The encapsulated pellet was then introduced into a tube furnace set to a temperature of 1000° C. A timeline of the SHS process is shown in FIG. 4 separated into six frames from T=0 seconds to T=11 seconds. The dotted line represents the encapsulated pellet. As shown in the timeline of FIG. 4, the self-propagating high-temperature synthesis reaction started within the first two seconds of introducing the sample at 1000° C. (Frame: 3 of FIG. 4). The ultra-fast reaction taking place was manifested with a bright glow which spread through the whole pellet and was quenched by the 11^{th} second of the sample residing in the furnace (Frame: 6 of FIG. 4).

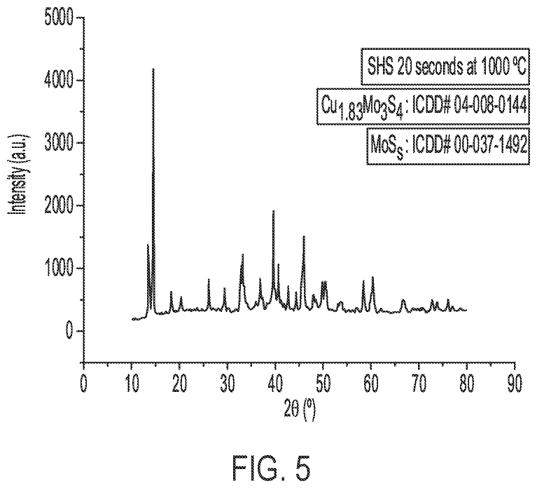

The as-processed material consisted of a mixture of non-stoichiometric Chevrel phase compound and MoS₂. The x-ray diffraction (XRD) results shown in FIG. 5 confirmed the presence of non-stoichiometric Cu_{2.76}Mo₆S₈ phase (ICDD-04-008-0144) and the hexagonal crystal structure of MoS₂ (ICDD-00-037-1492). This was consistent with typical reports of SHS where the formation of MoS₂ was unavoidable when elemental mixture was used, though typical reports did not provide explanation for the findings. Furthermore, the inventors did not anticipate MoS₂ formation in the experiment since the SHS reaction appeared to have consumed the whole pellet. Thus, the microstructure of the as-received material was investigated for evidence of the operating mechanism involved. The present disclosure therefore provides a plausible understanding for the typical presence of MoS₂ along with Chevrel phase compounds.

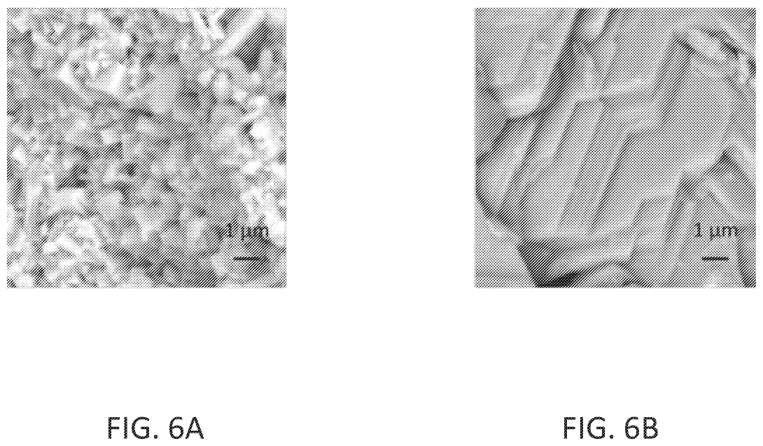

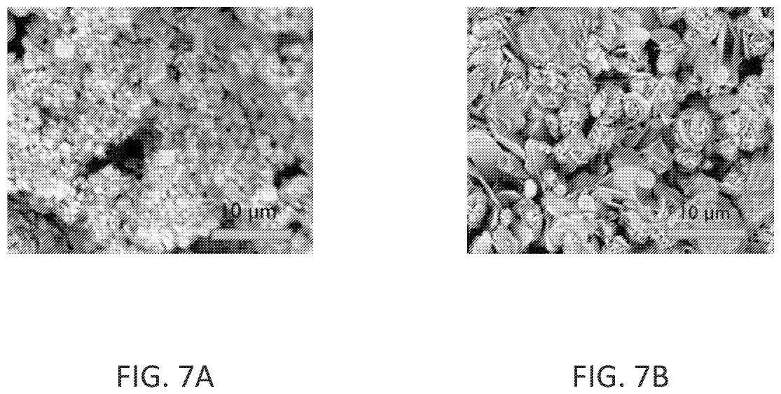

The morphology of Chevrel phase compound was very distinct from that of the MoS₂ phase. The Chevrel phase compound consisted of cube-like clusters with an average size of 650 nm and (size range 450 nm-1 um). The rosette-like MoS₂ structure consisted of plates, the thickness of which remained in submicron range; however, the plate size was a few microns (˜3 μm) wide. FIGS. 6A and 6B show scanning electron microscope (SEM) images that show the Chevron phase compound formed cubic clusters (FIG. 5A) while MoS₂ formed plates with spirals having nano-step (FIG. 6B). FIG. 7A illustrates a SEM image of cube-like clusters of the Chevrel phase compound and FIG. 7B illustrates a SEM image of rosette plates of MoS₂.

A step width λ=96 nm (average) and h=73 nm (average) for the spiral plate in FIG. 6B was reported. The value of slope based on the formula p=h/λ=Rₘ/vₛ was 0.76. A low value of p suggest that a value of supersaturation was also low since p∝σ (supersaturation) by comparing the below equations. Here, Rₘ is the growth rate normal to the surface and vₛ is the velocity in a lateral direction. Additionally, h is the height of each individual atomic layer, k_{B} is the Boltzmann constant, T is the temperature, ω is the specific molecular volume of crystal, α is the free energy of step edge, R is the Molar gas constant and ΔG is free energy change.

p=hkBT/)8×(ΔG/RT)

σ≡(ΔG/RT)

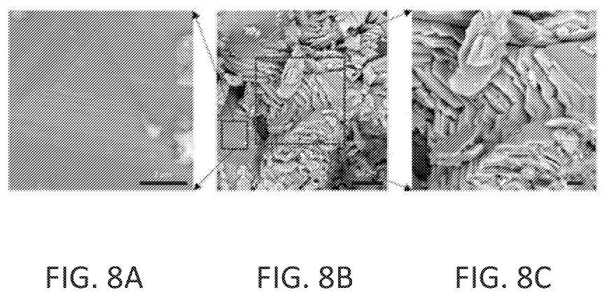

The MoS₂ morphology appeared to be a typical case of screw dislocation-driven (SDD) platelet growth. SEM micrographs revealed MoS₂ nanoplate morphology with zig-zag formation. Helical fringes provide direct evidence for the presence of the screw dislocation and hence screw-dislocation driven (SDD) spiral growth of MoS₂ nanoplates. FIG. 8A illustrates a SEM image showing the presence of a helical spiral indicated with a blue triangle. FIG. 8B illustrates a SEM image showing MoS₂ platelets that includes the helical spiral of FIG. 8A. FIG. 8C illustrates a SEM image showing MoS₂ spiral plates with nano-step formation included in SEM image of FIG. 8B.

The supersaturation of the system determines crystal growth dominated either by dislocation-driven, layer by layer (LBL) formation or dendritic growth. At lower supersaturation, the screw dislocation is capable of bulk crystal growth. The step edge created by the line of screw dislocation on the crystal surface continues to grow as spiral. According to Burton-Cabrera-Frank (BCF) theory, the new crystal will not nucleate since there will always be an edge present to which atoms can be added. Thus, below a certain critical supersaturation limit (σ*), crystal growth will take place in the form of spiral.

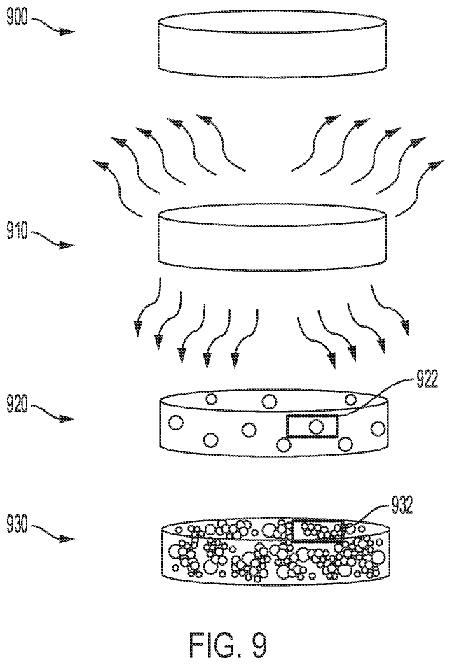

Based on these experiments, FIG. 9 illustrates a schematic of a presently disclosed plausible reaction mechanism during self-propagating high temperature synthesis of a Chevrel phase compound. At 900, a pellet of an elemental mixture of Cu, Mo, and S is unreacted. At 910, sulfur would start to sublimate due to its lower boiling temperature (444.6° C.) and begin to cover the molybdenum particles. At 920, sudden sublimation is likely to have caused a momentary increase in supersaturation of sulfur that led to the formation of one or more screw dislocations 922 and subsequent crystal growth by screw dislocation-driven (SDD) growth. Here, formation of MoS₂ is instantaneous and occurred at a very low temperature range (SHS of MoS₂ occurs in the temperature range of 360-365° C.). At 930, as soon as the system reached 1000° C., the SHS reaction took place between the unreacted copper, molybdenum and sublimated sulfur mixture to form non-stoichiometric Chevrel phase compound 932. The non-stoichiometric Chevrel phase compound was formed from elemental reaction as the combustion front passed through the pellet at a speed of 6.75 mm/second leaving already formed MoS₂ clusters in the pellet undisturbed. The sudden loss in sulfur content during MoS₂ formation disrupted the stoichiometry of the elemental mixture and hence, instead of the anticipated Chevrel phase compound with Cu₂Mo₆S₈, a copper-rich CP compound, Cu_{2.76}Mo₆S₈ was formed.

Accordingly, rapid self-propagating high temperature synthesis reaction was successfully utilized for scalable synthesis of copper Chevrel phase compounds. The Chevrel phase compound was obtained at 1000° C. within 11 seconds of being exposed to high temperatures in a tube furnace as compared to conventional heat-treatments that may take around 60 or more hours. The SHS reaction that was initiated within two seconds of the glass ampule enclosed sample being immersed in the 1000° C. environment resulted in a combustion front, which produced the non-stoichiometric Cu_{2.76}Mo₆S₈ phase via the highly exothermic reaction. The presence of MoS₂ in the as-processed sample was the result of sulfur evaporation and sublimation before the SHS process could initiate. Subsequent experiments by the inventors showed that an Ar environment yielded a higher amount of Chevrel phase compound. Subsequent experiments by the inventors also showed that better mixing of the elemental precursors in the pellet yielded a higher amount of Chevrel phase compound. Typically, the complete conversion of Cu—Mo—S to stoichiometric Chevrel phase compounds has been achieved by lengthy heat-treatments.

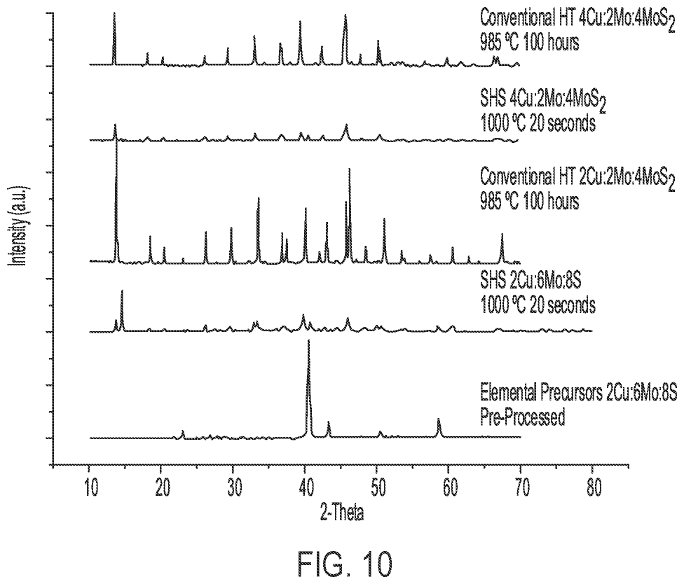

FIG. 10 illustrates XRD data for material synthesized via the provided Chevrel phase compound synthesis method and for material synthesized via a conventional Chevrel phase compound synthesis methods. In FIG. 10, a conventional Chevrel phase compound synthesis method is heat treatment at 985° C. for 100 hours. The provided method (e.g., 20 seconds) was performed in a significantly reduced amount of time as compared to the conventional method (e.g., 100 hours).

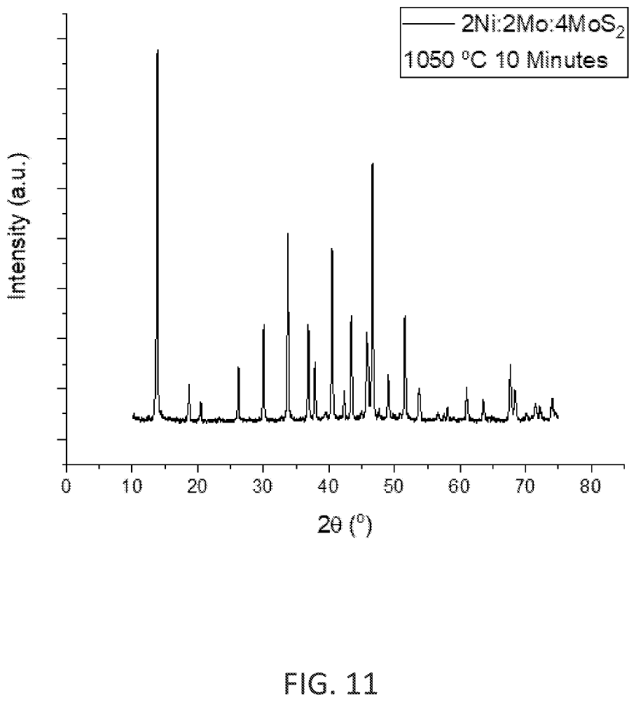

The inventors additionally synthesized a Ni₂Mo₆S₈ Chevrel phase compound using the provided method. FIG. 11 illustrates the XRD pattern of the synthesized Ni₂Mo₆S₈ sample that the inventors obtained. To synthesize the Ni₂Mo₆S₈ Chevrel phase compound, the combined set of elemental precursors Ni powder, Mo powder, and MoS₂ powder were encapsulated under vacuum, and the encapsulated sample was held in a tube furnace at a temperature of 1050° C. for 10 minutes. As such, the Ni₂Mo₆S₈ Chevrel phase compound was synthesized in a significantly reduced amount of time as compared to conventional methods.

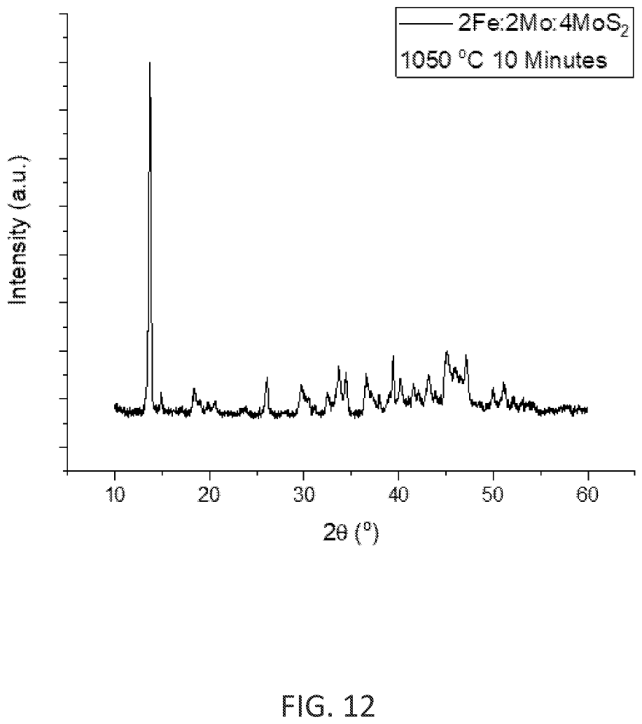

The inventors additionally synthesized a Fe₂Mo₆S₈ Chevrel phase compound using the provided method. FIG. 12 illustrates the XRD pattern of the synthesized Fe₂Mo₆S₈ sample that the inventors obtained. To synthesize the Fe₂Mo₆S₈ Chevrel phase compound, the combined set of elemental precursors Fe powder, Mo powder, and MoS₂ powder were encapsulated under vacuum, and the encapsulated sample was held in a tube furnace at a temperature of 1050° C. for 10 minutes. As such, the Fe₂Mo₆S₈ Chevrel phase compound was synthesized in a significantly reduced amount of time as compared to conventional methods.

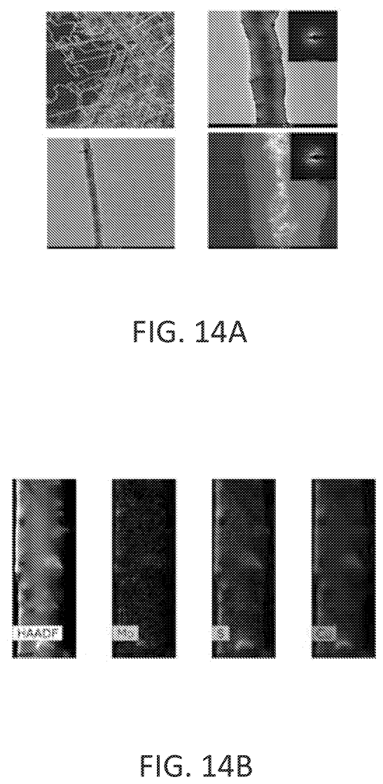

In preliminary studies of the Cu—Mo—S system, the inventors employed a combination of high-throughput electrospinning and SHS, where non-woven mats containing each of the three elements were layered up and were heat-treated at low temperatures and short times in an Ar atmosphere. FIGS. 14A and 14B show transmission electron micrographs of the resulting microstructures and their composition. For instance, the resulting “pipeline”-type microstructures obtained are shown.

Furthermore, the inventors produced —MoO₃ particles by flame-spray pyrolysis (FSP) using sol-gel precursors. In an example, a desktop Tethis nps 10 synthesizer was used. The solution was then filled in a syringe and fed into the FSP system at a rate of 5 mL/min. The flame was comprised of 1.5 slm (standard liters per minute) methane and 3.0 slm oxygen gas. A 5 slm oxygen gas flow was used as dispersion gas. The particles obtained after the FSP process (as-synthesized particles) were black in color. Upon thermal treatment at 500° C. for 5 hours, the color of the particles changed to white (calcined).

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A method for synthesizing a Chevrel phase compound comprising:
combining a set of elemental precursors including molybdenum (Mo), molybdenum disulfide (MoS₂), and a ternary cation;
subjecting the combined set of elemental precursors to an environment adapted for self-propagating high temperature synthesis of the combined set of elemental precursors, thereby synthesizing a Chevrel phase compound; and
removing the synthesized Chevrel phase compound from the environment.

2. The method of claim 1, wherein the ternary cation is copper (Cu).

3. The method of claim 1, wherein the ternary cation is iron (Fe).

4. The method of claim 1, wherein the ternary cation is nickel (Ni).

5. The method of claim 1, wherein the synthesized Chevrel phase compound has at least one of catalytic, photocatalytic, and sorbent properties.

6. The method of claim 1, wherein the Chevrel phase compound is synthesized in 10 minutes or less of the combined set of elemental precursors being subjected to the environment.

7. The method of claim 1, wherein the Chevrel phase compound is synthesized in less than 15 seconds of the combined set of elemental precursors being subjected to the environment.

8. The method of claim 1, wherein the synthesized Chevrel phase compound does not require further treatment subsequent to the self-propagating high temperature synthesis.

9. The method of claim 1, wherein the environment is within a tube furnace.

10. The method of claim 1, wherein the combined set of elemental precursors is encapsulated within an encapsulating instrument when subjected to the environment.

11. The method of claim 10, wherein the encapsulating instrument is a quartz tube.

12. The method of claim 10, wherein the air is removed from the atmosphere within the encapsulating instrument.

13. The method of claim 10, wherein the combined set of elemental precursors is encapsulated within an argon (Ar) atmosphere within the encapsulating instrument.

14. The method of claim 1, wherein the environment has a temperature greater than or equal to 800° C. and less than or equal to 1100° C.

15. The method of claim 1, wherein the environment has a temperature of 1000° C.

16. The method of claim 1, wherein the environment has a temperature of 1050° C.

17. The method of claim 1, wherein combining the set of elemental precursors includes electrospinning the set of elemental precursors.

18. The method of claim 17, wherein the synthesized Chevrel phase compound is in the form of nanofibers.

19. A method for synthesizing a Chevrel phase compound comprising:
combining a set of elemental precursors consisting of copper (Cu), molybdenum (Mo) and molybdenum disulfide (MoS₂);
encapsulating the combined set of elemental precursors in an encapsulating instrument;
subjecting the encapsulated combined set of elemental precursors to an environment adapted for self-propagating high temperature synthesis of the combined set of elemental precursors, thereby synthesizing a Chevrel phase compound; and
removing the synthesized Chevrel phase compound from the environment,
wherein the environment has a temperature of 1000° C.

20. A method for synthesizing a Chevrel phase compound comprising:
combining a set of elemental precursors consisting of (i) molybdenum (Mo), (ii) molybdenum disulfide (MoS₂), and (iii) nickel (Ni) or iron (Fe);
encapsulating the combined set of elemental precursors in an encapsulating instrument;
subjecting the encapsulated combined set of elemental precursors to an environment adapted for self-propagating high temperature synthesis of the combined set of elemental precursors, thereby synthesizing a Chevrel phase compound; and
removing the synthesized Chevrel phase compound from the environment,
wherein the environment has a temperature of 1050° C.
